(19) United States
(12) Patent Application Publication
(10) Pub. No.: US 2004/0038102 A1
(43) Pub. Date: Feb. 26, 2004

(54) Fuel cell stack

(76) Inventors: Jorg Beckmann, Friedrichshafen (DE); Gustav Boehm, Ueberlingen (DE); Ottmar Schmid, Markdorf (DE); Markus Schudy, Ludwigsburg (DE)

Correspondence Address: Davidson Davidson & Kappel, 485 Seventh Avenue, 14th Floor, New York, NY, 10018, US

(21) Appl. No.: 10/380,503

(22) PCT Filed: Sep. 21, 2001
(86) PCT No.: PCT/DE01/03657

(30) Foreign Application Priority Data
Sep. 23, 2000 (DE) 100 47 248.6

(51) Int. Cl. H01M 8/10; H01M 8/24

(52) U.S. Cl. 429/32; 429/38

(57) ABSTRACT

The invention relates to a fuel cell stack, comprising alternately arranged membrane-electrode units (3) and separator plates (2, 2a) for the introduction and removal of the reactant and oxidative fluid, whereby the separator plate (2, 2a) has a surface structure and the opposing face has the negative surface structure, by means of a shaping process. According to the invention, on stacking the separator plates (2, 2a), the surface structure of a separator plate (2) is opposite the corresponding negative surface structure of the neighboring separator plate (2a).

The present invention relates to an electrochemical cell stack, in particular a PEM or DMFC fuel cell stack, or an electrolysis cell stack according to the preamble of Patent claim 1.

Electrolysis cells are electrochemical units which generate chemicals such as hydrogen and oxygen on catalytic surfaces of electrodes upon input of electric power. Fuel cells are electrochemical units which generate electricity by converting chemical energy on catalytic surfaces of electrodes.

Electrochemical cells of this type include the following main components:

a cathode on which the reduction reaction takes place through addition of electrons. The cathode has at least one electrode carrier layer which functions as a carrier for the catalyst;

an anode on which the oxidation reaction takes place with the release of electrons. Like the cathode, the anode has at least one carrier layer and catalyst layer;

a matrix situated between the cathode and anode, functioning as a carrier for the electrolyte. The electrolyte may be in solid phase or liquid phase or it may be a gel. The solid-phase electrolyte is advantageously bound in a matrix to form a solid electrolyte.

These three components listed above are also known as a membrane electrode assembly (MEA), with the cathode electrode applied to one side of the matrix and the anode electrode applied to the other side.

a separator plate which is situated between the MEAs and has the function of collecting the reactants and oxidants in electrochemical cells.

sealing elements which prevent mixing of the fluids in the electrochemical cell and also prevent leakage of the fluid out of the cell and into the environment.

When electrolysis cells or fuel cells are stacked together, the result is an electrolysis stack or fuel cell stack, also referred to below simply as a stack. In this stack, the electric current flows from cell to cell in a series connection. Fluid management of the oxidant and reactants is performed via collecting and distributing channels to the individual cells. The cells of a stack are supplied with the reactant and oxidant fluid, e.g., in parallel via at least one distributing channel for each fluid. The reaction products as well as excess reactant and oxidant fluid are sent out of the cells and out of the stack via at least one collecting channel.

For economical use of electrolysis cells or fuel cells for mobile applications, the manufacturing costs must be comparable to those of internal combustion engines at comparable performance levels. To operate mobile systems using electric motors, cell stacks having a plurality of cells (>300 units) are needed, so low unit costs of the cell components are important. The unit cost includes both the cost of materials and production costs.

U.S. Pat. No. 6,040,076 describes a fuel cell stack for a molten carbonate fuel cell (MCFC). These fuel cells may be used only in the high temperature range (approx. 650° C.). In addition, a separator plate for fluid distribution is also described. The separator plate is produced by shaping a flat plate, and has a surface structure for distribution of the oxidant on one side and a negative surface relative to the former on the other side, the latter being for distribution of the reactant. The MEA is situated between the separator plates, and the electrolyte contained in the MEA is designed to be relatively thick in relation to comparable fuel cell stacks. This extremely stable structure of the MEA prevents the egg carton effect, as it is known. The egg carton effect is understood to refer to the effect whereby two identically structured plates collapse into one another in a form-fitting manner when stacked together. One disadvantage, however, is the high cell thickness of the fuel cells due to the relatively great thickness of the MEAs.

The object of the present invention is to create an electrochemical cell stack in a compact design having a low cell thickness in which the MEAs in between are not destroyed by the egg carton effect when the separator plates are stacked.

This object is achieved through the electrochemical cell stack according to Patent claim 1. Special embodiments of the present invention are the object of the subclaims.

According to the present invention, when stacking the separator plates, one surface structure of a separator plate is opposite a corresponding negative surface structure of the next separator plate. Thus, the structured separator plates do not collapse into one another when stacked but instead support one another mutually so that a flat MEA situated in between is neither deformed nor destroyed. Thus, in the electrochemical cell stack according to the present invention, destruction of the MEA due to the egg carton effect is prevented. Another advantage of the electrochemical cell stack according to the present invention is the greatly reduced cell thickness, and associated with that, a more compact design. In addition, an improved output per unit volume is achieved with the electrochemical cell stack according to the present invention, resulting in lower manufacturing costs for the cell stack according to the present invention.

MEAs having a small thickness may be used in the electrochemical cell stack according to the present invention. Such a membrane electrode assembly includes:

a membrane, e.g., a polymer membrane having a thickness in the range of 10-200 μm;

a catalyst layer, e.g., carbonca is applied to both sides of the MEA in a thickness in the range of 5-15 μm;

a gas diffusion structure applied to the catalyst layer, e.g., porous graphite paper having a thickness in the range of 50-500 μm.

The surface area of an MEA usually depends on the size of the separator plate, and in particular the MEA completely covers the separator plate.

The electrode constructed from the catalyst layer and the gas diffusion layer functions as a cathode on one side of the MEA and as an anode on the other side of the MEA. This yields MEAs less than 1 mm thick, which do not have a rigid surface. Therefore, this makes it possible to greatly reduce the cell thickness and thus lower the cost of manufacturing the cell stack. This yields another advantage in increased output per unit volume of the electrochemical cell stack.

The separator plates are preferably manufactured of conductive materials such as metals (e.g., steel or aluminum), conductive plastics, carbons or composits. The separator plates are manufactured in particular with the help of mechanical shaping techniques, e.g., roll forming, magnetic shaping, rubber body shaping, gas or liquid pressure shaping, or embossing. This permits a reduction in manufacturing cost. The wall thickness of a separator plate is usually between 0.1 mm and 0.5 mm. The area of the separator plate to be formed will depend on the field of application in which the electrochemical cell stack is used.

The separator plate advantageously includes:

an active channel region which is usually situated centrally on the separator plate, where the fluid comes in contact with the MEA;

perforations for the ports which are used for supplying and removing the reactant and oxidant fluid into and from the separator plate;

distributor regions for influencing the fluid distribution from the port regions to the active channel region.

The electrode constructed from the catalyst layer and the gas diffusion layer is advantageously applied to the membrane in the area of the active channel region of the separator plate. However, it is possible for this electrode to also be applied to the membrane in the area of the distributor region of the separator plate. This yields a larger active catalytic region, which results in a greater output per unit volume of the cell stack according to the present invention. However, it is also possible for the electrode constructed of the catalyst layer and the gas diffusion layer to cover the entire surface of the MEA.

In a preferred embodiment of the present invention, the distributor region of the separator plates has a nub structure. A good homogeneous distribution of the fluids is achieved via the essentially circular nubs. This results in a uniform flow through the active channel region. The maximum height of the nubs advantageously corresponds to the maximum height of the channel structure of the active channel region.

In another preferred embodiment of the present invention, the distributor regions of the separator plate may form a separate component, e.g., another plate. This component advantageously may have a nub structure. The separate component may be made, e.g., of a metal, a polymer, a polymer-metal composite material or a ceramic. Joining of the separate component to the separator plate may be accomplished through conventional bonding techniques, e.g., welding, gluing, soldering or bending. One advantage of the separate component is the integration of other distributor structures into the separator plate, so that an improved distribution of fluids may be achieved.

The separator plate advantageously has sealing regions on both sides. These sealing regions, in addition to sealing the separator plates with respect to one another and to the outside, also have the function of sealing individual regions on a separator plate, e.g., sealing adjacent ports. The sealing regions are characterized by impressed depressions in the form of channels filled with sealing bodies. The depressions are situated in such a way that the sealing bodies lie one above the other, separated by the separator plate. The height of the sealing bodies is preferably greater than the maximum height of the impressed depressions in the form of channels. Thus a good sealing effect is achieved when the separator plates are stacked. However, it is also possible for the sealing regions to be formed by other sealing techniques, e.g., flanging with an intermediate insulation layer or casting with thermosetting substances, e.g., polymers.

When the separator plates are stacked, the force applied to the sealing bodies is advantageously applied essentially at a right angle to the separator plate and at a right angle to the sealing bodies. Thus, pushing and shearing stresses within the sealing bodies are prevented, which results in a longer lifetime of the sealing bodies, while yielding a better sealing effect. Furthermore, this prevents destruction of the MEAs.

In another advantageous embodiment of the present inventions, the separator plate has impressed depressions in the form of channels, in particular in the port regions. Each port is completely sealed on one of the two sides of the separator plate, e.g., with a seal running around the port, due to the flow guided on the sides of the separator plate. These impressed depressions in the form of channels are designed so that a channel-like guide is formed on the one side in which a sealing body may be placed. On the other side facing away from the seal, this corresponding elevation forms a supporting point for the MEA. The height of the depression should correspond to the maximum height of the depressions in the active channel region and distributor region. The advantage of these supporting points is that the MEA is not destroyed when the separator plates are stacked.

The sealing bodies may be in particular detachable seals, e.g., O-rings, or a polymer compound, so that the separator plate remains reusable after replacing the seals. It is also possible for the sealing bodies to be applied to the MEA in the form of a sealing bead. This permits rapid replacement of the MEAs.

In addition to the advantages already described, a homogeneous temperature distribution may be achieved with the separator plate in the electrochemical cell stack according to the present invention. This prevents the formation of hot spots (high temperature areas) which would destroy the MEAs. In addition, the cell stack according to the present invention may be used at a temperature of up to 150° C.

One area for application of the fuel cell stack according to the present invention is for power supply in mobile systems, e.g., motor vehicles, rail vehicles, and aircraft. Another possible application of the fuel cell stack according to the present invention is for power supply in electronic devices. In addition, the fuel cell stack according to the present invention may also be used as an independent power generating module.

The present invention is described in greater detail below on the basis of figures, which show:

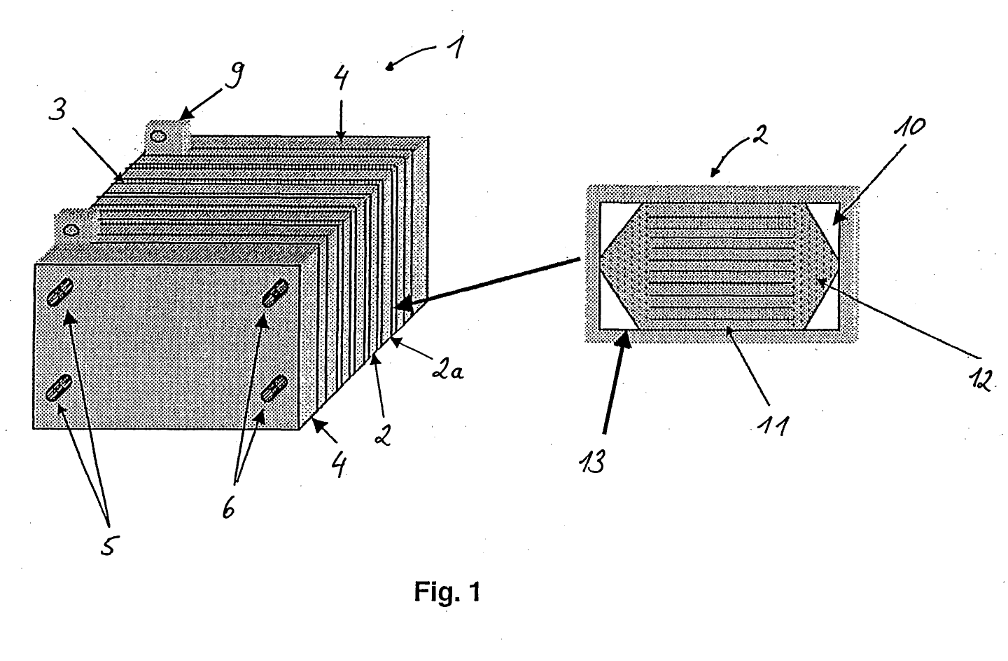

FIG. 1 the design of the electrochemical cell stack according to the present invention for an overview and explanation of the overall design;

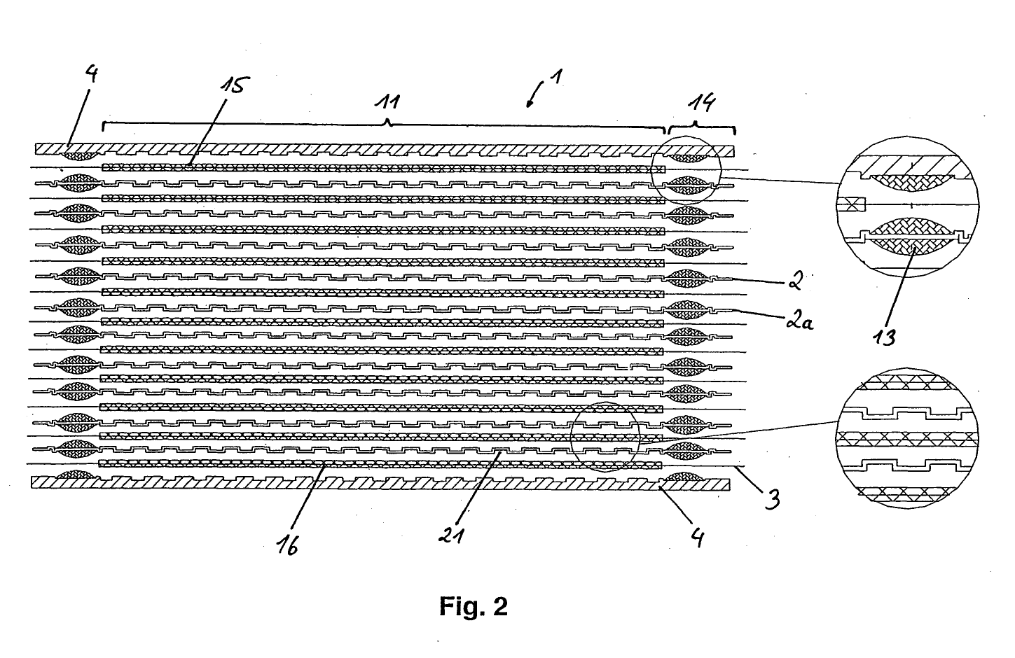

FIG. 2 a section through a fuel cell stack according to the present invention in the area of the active channel region;

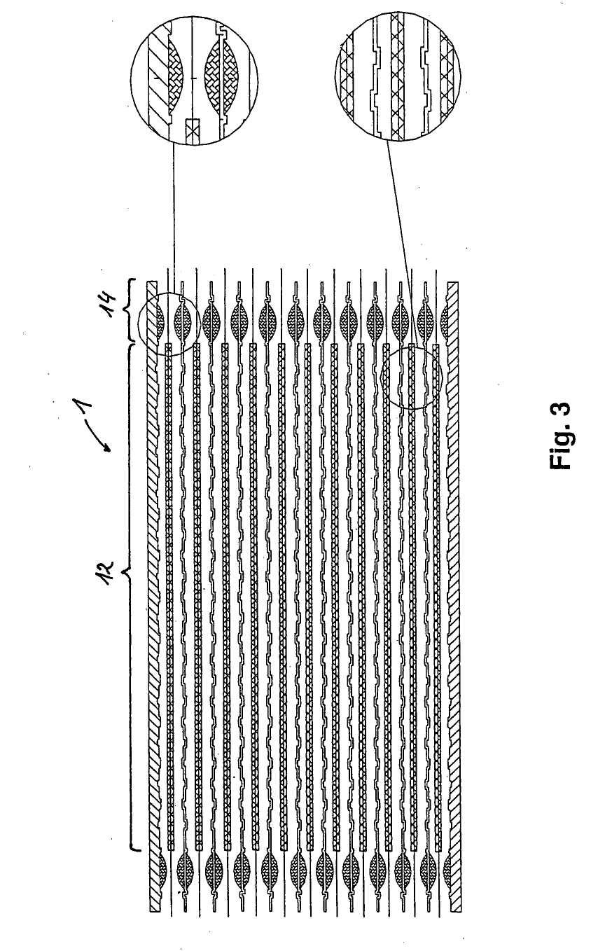

FIG. 3 a section through a fuel cell stack according to the present invention in the area of the distributor region;

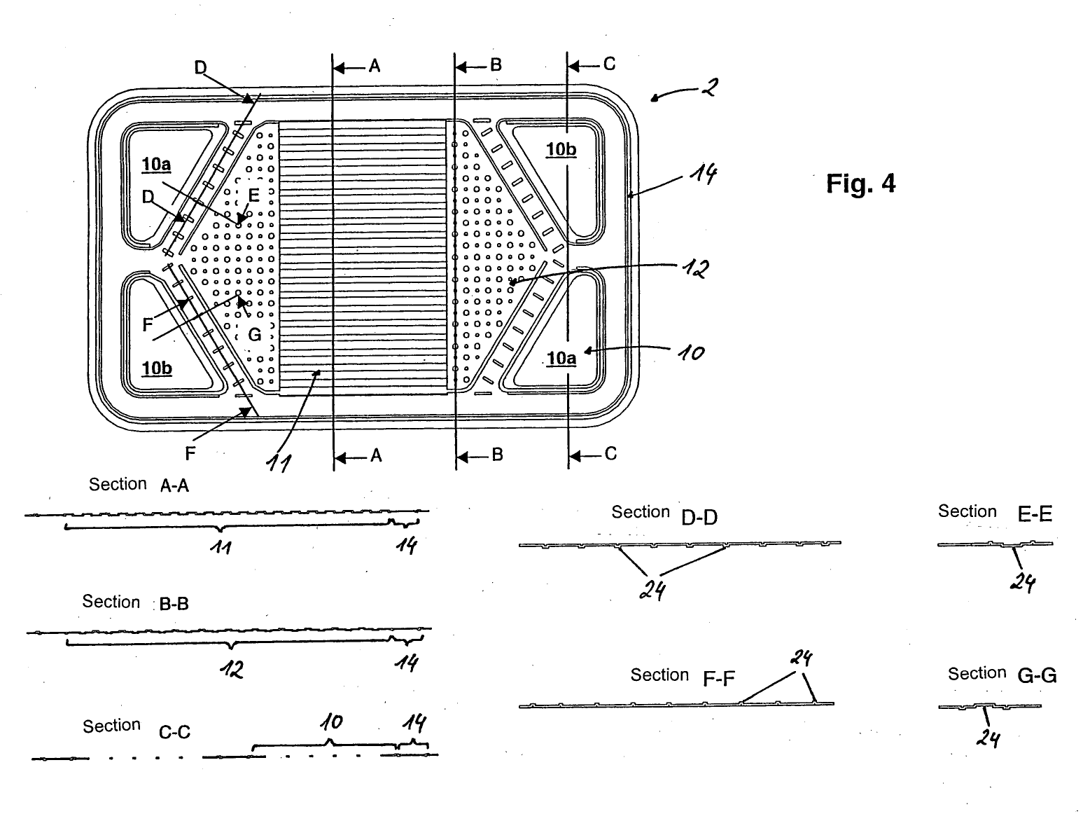

FIG. 4 a detailed diagram of the port region, the active region, the distributor region, and the sealing region in a first embodiment of a separator plate in a fuel cell stack according to the present invention;

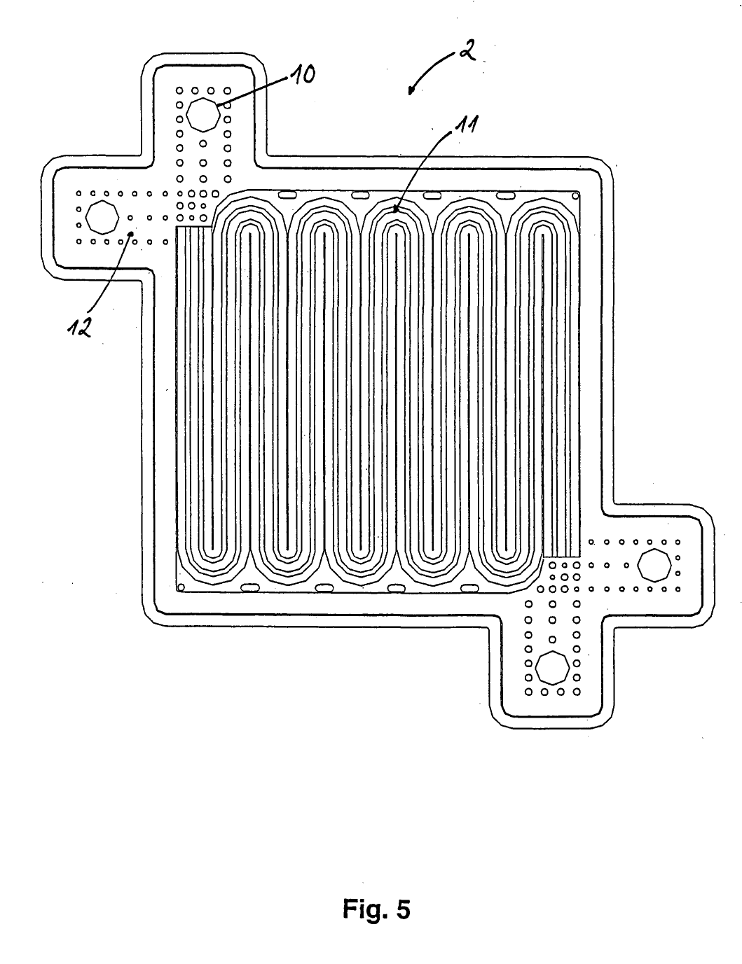

FIG. 5 a detailed diagram of a second embodiment of a separator plate having a serpentine channel structure of the active channel region.

In the figure on the left, FIG. 1 shows a fuel cell stack 1 according to the present invention which is composed of separator plates 2 and 2a and membrane electrode assemblies 3 (MEA), which alternate. The figure on the right shows the structure of a separator plate 2 of the stack. Separator plates 2 and 2a are neighboring plates, the opposite sides of the two plates having a positive structure and a corresponding negative structure. Therefore, an MEA 3 situated between a separator plate 2 and a separator plate 2a is not damaged. Stack 1 also has end plates 4 which permit fuel cell stack 1 to be pressed together. In addition, two ducts 5, 6 are provided for carrying the fluid to and away from the reaction gases. Plates 9 of electrically conducting material are for current pickup. However, current may also be collected directly via separator plates 2. In operation, the reactant is supplied via one side of separator plate 2 in this embodiment and the oxidant is supplied via the rear side.

Separator plate 2, 2a having structured surfaces on both sides has four perforations (ports) 10 for ducts 5, 6 for the supply and removal of fluid. In addition, a structure for active channel region 11 is also provided on both sides of separator plate 2, 2a. A distributor region 12 is provided for distributing the fluid from ports 10 to active channel region 11. The two fluids, namely the reactant and the oxidant, are sealed with respect to the outside and to one another by seals 13.

FIG. 2 shows a section through a fuel cell stack according to the present invention, illustrating the region of active channel region 11 in an exploded diagram according to section A-A in FIG. 4. Fuel cell stack 1 composed of structured separator plates 2 and 2a with MEAs 3 alternating in between them is bordered by end plates 4. Active channel region 11 of a separator plate 2, 2a is characterized by directly successive channel-like structures. These structures may be rectangular or corrugated, for example.

In the area of active channel region 11, anode 15 is situated on one side of MEA 4 and cathode 16 is situated on the rear side of MEA 3. However, it is also possible to widen the area of anode 15 and the area of cathode 16 to the distributor region of the collecting and distributor channels 12 (FIG. 3). In addition, the area of anode 15 and the area of cathode 16 may also be widened to the sealing region 14 (not shown). The porous electrode layer is impregnated in sealing region 14, thus preventing a cross flow of fluids.

MEA 3, situated between a separator plate 2 and a separator plate 2a, rests on the surface structure of separator plate 2 on one side and on the corresponding negative surface structure of neighboring separator plate 2a on the rear side. This ensures that, first, MEA 3 in between is not destroyed when separator plates 2 and 2a are stacked. Second, cavities 21 are formed by this stacking, so that the oxidant flows into these cavities on one side of MEA 3 and the reactant flows there on the rear side of MEA 3.

At the edges of separator plates 2, 2a, active channel region 11 is bordered by a sealing region 14. Sealing region 14, which is shown on an enlarged scale in the upper detail in FIG. 2, is characterized by two neighboring structures. These structures are created on both surfaces of separator plate 2, 2a, each to a maximum height. This maximum height is determined by the height of active channel region 11 and distributor region 12. Between these two structures there is a region into which a sealing body 13 may be placed on both sides of separator plate 2, 2a. A sealing structure of a neighboring separator plate 2, 2a has a sealing region 14 having corresponding negative structures so that when separator plates 2 and 2a are stacked, MEA 3 in between is not destroyed.

Due to the stacking of separator plates 2, 2a, MEA 3 in between is secured first of all with the help of sealing body 13 and furthermore active channel region 11 is sealed to the outside.

End plates 4 have negative structures corresponding to neighboring separator plate 2 or 2a. These structures are expediently designed on the surface of end plate 4 which faces the inside of the stack.

In an exploded diagram, FIG. 3 shows a section through a fuel cell stack according to the present invention along line B-B in FIG. 4, showing distributor region 12 having adjacent sealing region 14. The structure of sealing region 14 corresponds to the structure of sealing region 14 in FIG. 2.

Distributor region 12 is characterized by essentially circular structures (nubs) situated on both sides of separator plate 2, 2a. The nub height corresponds to the maximum height of the channel structure of the active channel region. The spacing of the nubs depends on the amount of fluid to be throughput through distributor region 12. The nubs provide a homogeneous distribution of the fluids to active channel region 11.

In a first embodiment of a separator plate 2, 2a FIG. 4 shows port region 10, active channel region 11, distributor regions 12 and sealing region 14 in a detailed diagram as an example.

Separator plate 2 has two passages for ports 10a and ports 10b, arranged opposite one another. In countercurrent fluid flow, ports 10a are used to supply fluid, and ports 10b are used to remove fluid. One of two ports 10a for supplying fluid supplies the channel system (distributor region 12 and active channel region 11) on one side of separator plate 2, while the other of two ports 10a supplies the channel system on the rear side of separator plate 2.

Section A-A shows active channel region 11 together with adjacent sealing region 14. Active channel region 14 is characterized by an alternating surface structure, with a depression on one surface of the separator plate corresponding to an elevation on the rear side of the separator plate.

Distributor region 12 together with adjacent sealing region 14 is shown in section B-B. Webs are situated between the structures (nubs) on one face of the separator plate. Distributor region 12 is characterized by an essentially regular arrangement of structures, with neighboring structures facing in opposite directions (up, down). The maximum nub height corresponds to the maximum height of the channel structure of active channel region 11.

Sealing region 14, which borders ports 10a, 10b, is illustrated in section C-C. Sealing region 14 is characterized by guides opposite one another on both sides of the separator plate. A sealing body may be inserted into these guides on both sides. This ensures that when the separator plates are stacked, any force exerted on the separator plate and the sealing bodies will be directed perpendicularly to the separator plate and the sealing bodies. The guides are bordered on both surfaces by structures in the separator plate, thus yielding a means of securing the sealing bodies. The height of the structures here corresponds to the maximum height of the channel structure of active channel region 11 and of distributor region 12.

Both ports 10a and both ports 10b are sealed relative to one another on both sides of the separator plate. On one side of the separator plate, one of the two ports 10a has a flow connection to one of the two ports 10b. Other ports 10a and 10b are completely sealed by sealing bodies on this side of the separator plate. On the rear side of the separator plate, precisely these ports 10a and 10b are in flow connection—precisely these ports are sealed on the opposite side of the separator plate. Other ports 10a and 10b on this side of the separator plate are completely sealed by sealing bodies.

Each port 10a, 10b is thus sealed on one side of the separator plate. On the other side of the separator plate facing away from the seal, there are supporting points 24 which prevent the MEA from collapsing. Collapsing of the MEAs would mean a reduction in the flow cross section in the channel structure, which might result in an uneven distribution of fluids. These supporting points 24 are shown in section D-D and section E-E for one of two ports 10a as an example. Section D-D shows that in port region 10, supporting points 24 are present exclusively on the lower side of the separator plate. Section E-E shows the detailed pattern of the guide for the sealing body on the upper surface of the separator plate. Two structures provided on the upper side of the separator plate form a border for a sealing body. Between these structures, there is another structure which functions as a supporting point 24 on the lower side of the separator plate.

Section F-F and section G-G illustrate the pattern of supporting points 24 for the other of two ports 10a. The structures described here are negative and correspond to the structures in section D-D and section E-E.

Ports 10b also have a corresponding pattern of supporting points 24 and sealing guides.

FIG. 5 shows another embodiment of a separator plate 2. Active channel region 11 is designed with a serpentine pattern. Ports 10 for supplying and removing fluid are situated at two diametrically opposite corners of separator plate 2. Distributor regions 12 are provided in the area of ports 10 for the distribution of fluids. These distributor regions 12 advantageously may also have a nub structure. Ports 10 are sealed relative to one another in accordance with the discussion with regard to FIG. 4.

List of Reference Numbers

1 fuel cell stack

2, 2a separator plate

3 Mea

4 end plate

5, 6 duct

9 current collector plate

10 ports

10a port region fluid supply

10b port region fluid removal

11 active channel region

12 distributor region

13 seal

14 sealing region

15 anode

16 cathode

21 cavity

24 supporting points

What is claimed is:

1. An electrochemical cell stack, comprising an alternating arrangement of membrane electrode assemblies (3) and separator plates (2, 2a) for supplying and removing the reactant and the oxidant fluids, one side of the separator plate (2, 2a) having one surface structure and the other side having a negative surface structure relative to the former formed by a shaping operation wherein when the separator plates (2, 2a) are stacked, one surface structure of a separator plate (2) faces a corresponding negative surface structure of the neighboring separator plate (2a).

2. The electrochemical cell stack as recited in one of the preceding claims,
wherein the separator plate (2, 2a) is manufactured by roll forming, rubber body shaping, magnetic shaping, gas or liquid pressure shaping, or embossing.

3. The electrochemical cell stack as recited in one of the preceding claims,
wherein the surface structure of the separator plate (2, 2a) has port regions (10) for supplying and removing the fluids into and from the separator plate (2, 2a), channel regions (1) for contacting the membrane electrode assemblies (3) having the fluids, and distributor regions (12) for influencing the fluid flow.

4. The electrochemical cell stack as recited in claim 3,
wherein the distributor regions (12) have a nub structure.

5. The electrochemical cell stack as recited in claim 3 or 4,
wherein the distributor regions (12) form a separate component.

6. The electrochemical cell stack as recited in claim 5,
wherein the separate component is composed of a metal, a polymer, a polymer-metal composite material or a ceramic and is joined to the separator plate (2, 2a) by welding, gluing, soldering or bending.

7. The electrochemical cell stack as recited in one of the preceding claims,
wherein the separator plate (2, 2a) has perforations for the port regions (10) for supplying and removing the reactant fluid and oxidant fluid into and from the channel regions of the separator plate (2, 2a).

8. The electrochemical cell stack as recited in one of the preceding claims,
wherein the separator plate (2, 2a) has impressed depressions in the form of channels on both sides, these channels being filled with sealing bodies (13) and situated one above the other, separated by the separator plate (2, 2a).

9. The electrochemical cell stack as recited in claim 8,
wherein the force between the separator plates (2, 2a) is directed almost perpendicularly through the sealing bodies (13) when the separator plates (2, 2a) are stacked.

10. The electrochemical cell stack as recited in claims 1 through 7,
wherein the separator plate (2, 2a) has impressed depressions in the form of a channel such that the sealing bodies (13) run on one side (22, 23) of the separator plate (2, 2a) in the depressions, and the corresponding elevations on the other side function at the same time as supporting points (24) for the membrane electrode assemblies (3).

11. (New) An electrochemical cell stack, comprising:
an alternating arrangement of membrane electrode assemblies and separator plates for supplying and removing reactant and oxidant fluids,
a first side of the separator plates having a first surface structure and the other side having a negative surface structure relative to the first surface structure, the first surface structure and the negative surface structure being formed by a shaping operation;
the separator plates being stacked, the first surface structure of a first separator plate facing the corresponding negative surface structure of a second separator plate neighboring the first separator plate.

12. (New) The electrochemical cell stack as recited in claim 11 wherein the first and second separator plates are manufactured by roll forming, rubber body shaping, magnetic shaping, gas or liquid pressure shaping, or embossing.

13. (New) The electrochemical cell stack as recited in claim 11 wherein the first surface structure of the first separator plate has port regions for supplying and removing fluids into and from the first separator plate, channel regions for contacting the membrane electrode assemblies having the fluids, and distributor regions for influencing flow of the fluid.

14. (New) The electrochemical cell stack as recited in claim 13 wherein the distributor regions have a nub structure.

15. (New) The electrochemical cell stack as recited in claim 13 wherein the distributor regions form a separate component.

16. (New) The electrochemical cell stack as recited in claim 15 wherein the separate component is composed of a metal, a polymer-metal composite material or a ceramic and is joined to the first separator plate by welding, gluing soldering or bending.

17. (New) The electrochemical cell stack as recited in claim 11 wherein the first separator plate has perforations for port regions for supplying and removing the reactant fluid and the oxidant fluid into and from channel regions of the first separator plate.

18. (New) The electrochemical cell stack as recited in claim 11 wherein the separator plates have impressed depressions in the form of channels on both sides, the channels being filled with sealing bodies and situated one above the other, separated by the separator plates.

19. (New) The electrochemical cell stack as recited in claim 18 wherein a force between the separator plates is directed almost perpendicularly through the sealing bodies when the separator plates are stacked.

20. (New) The electrochemical cell stack as recited in claim 11 wherein the separator plates have impressed depressions in the form of a channel such that sealing bodies run on one side of the separator plates in the depressions, and that corresponding elevations on the other side function at the same time as supporting points for the membrane electrode assemblies.
